(19) United States
(12) Patent Application Publication
(10) Pub. No.: US 2006/0092410 A1
(43) Pub. Date: May 4, 2006

(54) Container inspection by directly focusing a light emitting die element onto the container

(75) Inventors: Stephen M. Graff, Maumee, OH (US); Dean F. Margalski, Toledo, OH (US); James A. Ringlien, Maumee, OH (US)

Correspondence Address: OWENS-ILLINOIS, INC., ONE SEAGATE, 25-LDP, TOLEDO, OH, 43666, US

(73) Assignee: Owens-Brockway Glass Container Inc.

(21) Appl. No.: 10/977,149

(22) Filed: Oct. 28, 2004

(51) Int. Cl. G01N 21/88

(52) U.S. Cl. 356/239.4

(57) ABSTRACT

An apparatus for optical inspection of containers includes a light source having at least one light emitting diode with a light emitting die surface. Lenses and/or mirrors focus the light emitting die surface onto a selected portion of a container, and a light sensor receives an image of the selected portion of the container illuminated by the light source. An information processor is coupled to the light sensor for detecting commercial variations in the illuminated portion of the container as a function of the image received at the sensor. The image can be developed by transmission of the light energy through the selected portion of the container, and/or by reflection and/or refraction of the light energy at the selected portion of the container. The light source may include a single light emitting diode, or a plurality of light emitting diodes having light emitting die surfaces focused onto the container in such a way that the images of the light emitting die surfaces overlap and/or are adjacent to each other at the container.

The present invention is directed to inspection of containers for commercial variations that affect the optical properties of the containers, and more particularly to a method and apparatus for inspecting containers by directly focusing one or more LED light emitting die elements onto the portion of the container under inspection.

### BACKGROUND AND SUMMARY OF THE INVENTION

In the manufacture of containers such as glass bottles and jugs, various types of anomalies can occur in the sidewalls, heels, bottoms, shoulders, necks and/or finishes of the containers. These anomalies, termed “commercial variations” in the art, can affect the commercial acceptability of the containers. It has been proposed to employ electro-optical inspection techniques for detecting commercial variations that affect the optical properties of the containers. The basic principle is that a light source is positioned to direct light energy onto the container, and a light sensor is positioned to receive an image of the portion or portions of the container illuminated by the light source. The light source can be of uniform intensity, or can be configured to have an intensity that varies across one or more dimensions of the light source. Commercial variations in the portion of the container illuminated by the light source are detected as a function of light intensity in the image of the illuminated container portion received at the sensor. Such electro-optical inspection techniques also are employed to read undulations or surface variations in the container, such as at the container heel or bottom, indicative of a code associated with the mold of origin of the container. U.S. Pat. Nos. 4,945,228, 5,200,801 and 6,025,909 are representative.

Container inspection light sources typically include one or more incandescent bulbs, fluorescent tubes or LEDs. When using incandescent bulbs, the filaments typically are focused onto the illuminated portion of the container, either directly or through a diffuser. Fluorescent bulbs typically are employed in combination with a diffuser in an effort to achieve omnidirectional illumination. LEDs heretofore employed are low-power components having lenses or other focusing optics that do not permit direct focusing of the light emitting element or die. LED's typically are used in combination with diffusers to provide a source of omnidirectional illumination.

A general object of the present invention is to provide a method and apparatus for inspecting containers, in which the light source provides increased uniformity of illumination, improved reliability of inspection and reduced maintenance due to an increased operating lifetime of the light emitting component(s).

An apparatus for optical inspection of containers, in accordance with presently preferred embodiments of the invention, includes a light source having at least one light emitting diode with a light emitting die surface. Means, such as lenses or mirrors, focus the light emitting die surface onto a selected portion of a container, and a light sensor receives an image of the selected portion of the container illuminated by the light source. An information processor is coupled to the light sensor for detecting commercial variations in the illuminated portion of the container as a function of the image received at the sensor. The image can be developed by transmission of the light energy through the selected portion of the container, and/or by reflection and/or refraction of the light energy at the selected portion of the container. The light source may include a single light emitting diode or a plurality of light emitting diodes each having a light emitting die surface. The light emitting die surfaces may be focused onto the container in such a way that the images of the light emitting die surfaces overlap and/or are adjacent to each other at the container.

### BRIEF DESCRIPTION OF THE DRAWINGS

The invention, together with additional objects, features, advantages and aspects thereof, will best be understood from the following description, the appended claims and the accompanying drawings, in which:

FIG. 1 is a schematic diagram of an apparatus for optical. inspection of containers in accordance with one presently preferred embodiment of the invention;

FIG. 2 is an elevational view of the light emitting diode in the apparatus of FIG. 1;

FIG. 3 is a fragmentary schematic diagram of a modification to the system of FIG.

FIG. 4 is a fragmentary schematic diagram of a further embodiment of the invention; and

FIG. 5 is an elevational view of the pattern of illumination in FIG. 4, being taken from the direction 5 in FIG. 4.

### DETAILED DESCRIPTION OF PREFERRED EMBODIMENTS

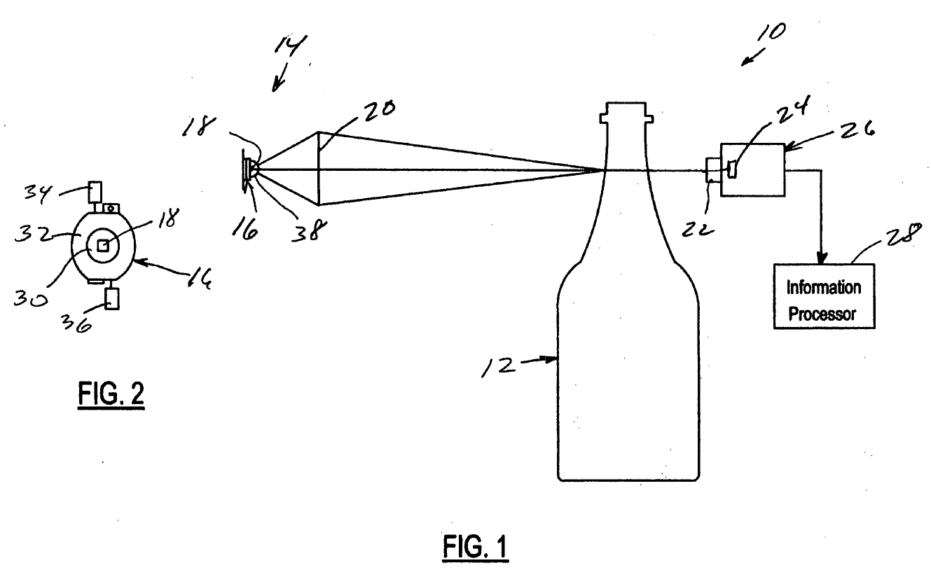

FIG. 1 is a schematic diagram of an apparatus 10 for optical inspection of a container 12. Apparatus 10 includes a light source 14 having at least one light. emitting diode 16 with a light emitting die 18. One or more lenses 20 focus the light emitting surface of die 18 directly onto a portion of container 12 selected for inspection. Mirrors may be employed instead of or in addition to lens(es) 20 for focusing the light emitting die surface onto the container. Light energy transmitted through, reflected from and/or refracted by the illuminated portion of container 12 is directed through a lens system 22 onto a light sensor 24 in a camera 26. Lens system 22 may be part of camera 26. An information processor 28 is connected to camera 26 to scan sensor 24 and thereby obtain an image of the illuminated portion of the container. Sensor 24 can be an area array sensor having a two-dimensional array of light sensing elements, or a linear array sensor having a one-dimensional array of light sensing elements. Information processor 28 can scan sensor 24 at suitable increments, such as increments of rotation of container 12.

As noted above, the light energy directed from container 12 onto sensor 24 can be transmitted through and/or reflected from and/or refracted by the portion of the container under inspection depending upon the type of inspection being performed. The following U.S. patents are illustrative of optical container inspection as a function of light transmitted through. and/or refracted at the container: U.S. Pat. Nos. 5,214,713, 5,233,186, 5,243,400, 5,291,271, 5,461, 228, 5,466,927, 5,753,905 and 5,969,810. The following U.S. patents are illustrative of container inspection as a function of light energy reflected from the container: U.S. Pat. No. 4,230,266, 4,584,469, 4,644,151, 4,945,228, 5,200,801, 5,489,987, 5,637,864, 5,896,195, 6,104,482, 6,175,107 and 6,256,095.

FIG. 2 illustrates one presently preferred configuration of LED 16. Light emitting die 18 is carried by a heatsink 30 on a base 32. Leads 34,36 are provided for electrical connection to die 18. Non-collimating optics 38 (FIG. 1) allow direct focusing of the light emitting surface of die 18 onto container 12. One presently preferred LED 16 is marketed under the trade designation Luxeon by Lumileds Lighting of San Jose, Calif. and transmits the light energy in a lambertian pattern.

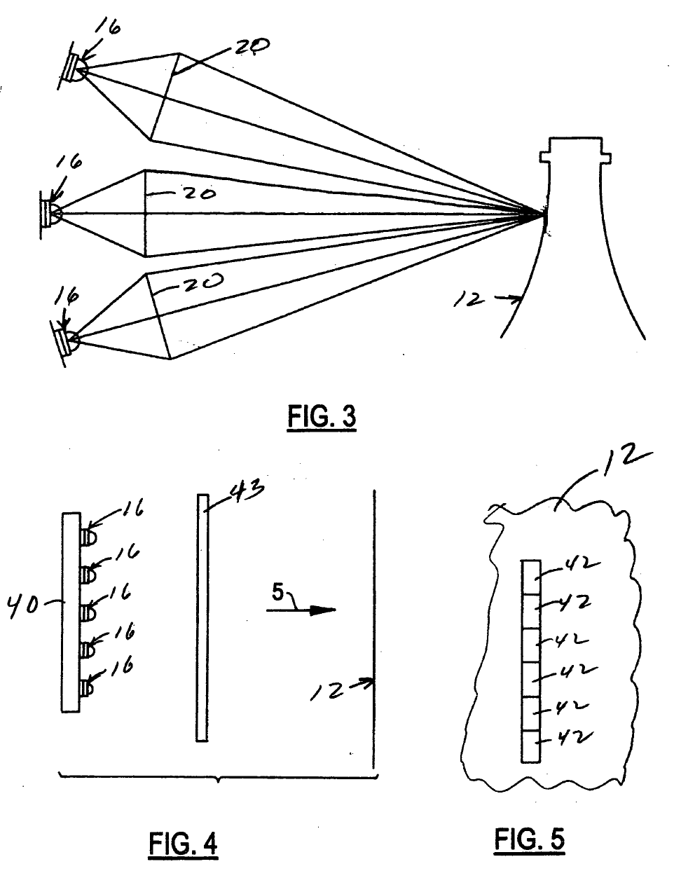

FIG. 3 illustrates a modification to the embodiment of FIG. 1, in which the light emitting die surfaces 18 of a plurality of LEDs 16 are focused by one or more associated lenses 20 (and/or mirrors) directly onto the surface of container 12 in such a way that the images of the light emitting die surfaces at least partially overlap at the container. This modification permits generation of an inspection light beam of substantial brightness. FIGS. 4 and 5 illustrate a modification in which a plurality of LEDs 16 are mounted on a heatsink support 40. The light emitting die surfaces of LEDs 16 are focused onto container 12 by a fresnel or other cylinder lens 43 in such a way the images 42 (FIG. 5) of the die surfaces are adjacent to each other and form a continuous linear illumination image at the container. LEDs 16 in FIGS. 4 and 5 may have the same or differing light transmission wavelengths, and there may be areas of overlap among the images 42. Other illumination patterns can be provided using suitable lenses and/or mirrors and/or patterns of LEDs 16 on support 40.

Focusing the light emitting die surface of one or more LEDs creates an illumination image that is bright and well defined at the container. The ability to stack the die images (FIGS. 3-5) allows clean and efficient illumination of the container portion under inspection. The relatively large sizes of dies 18 (0.05 inch×0.05 inch and larger) and the greater intensities allow replacement of incandescent and fluorescent bulbs, with a corresponding increase in the uniformity of illumination, the reliability of inspection and reduced maintenance. Stacking of the die images (FIGS. 3-5) allows the illumination intensity to be increased linearly, and allows the illumination pattern to be structured in any desired shape. Furthermore, the LEDs are essentially monochromatic, which readily permits filtering of ambient light.

There thus has been disclosed a method and apparatus for inspecting containers that fully satisfy all of the objects and aims previously set forth. The invention has been disclosed in conjunction with several presently preferred embodiments, and a number of modifications and variations have been discussed. Other modifications and variations readily will suggest themselves to persons of ordinary skill in the art in view of the present disclosure. The invention is intended to embrace all such modifications and variations as fall within the spirit and broad scope of the appended claims.

1. Apparatus for optical inspection of containers, which includes:
a light source including at least one light emitting diode having a light emitting die surface,
means for focusing said light emitting die surface onto a selected portion of a container,
a light sensor for receiving an image of the portion of the container illuminated by said light source and said means, and
an information processor coupled to said light sensor for detecting commercial variations in the illuminated portion of the container as a function of said image received at said sensor.

2. The apparatus set forth in claim 1 wherein said light source includes a plurality of said light emitting diodes, each having a light emitting die surface, and wherein said means focuses the light emitting die surfaces of all of said light emitting diodes onto said selected portion of the container.

3. The apparatus set forth in claim 2 wherein said means are such that at least some images of said light emitting die surfaces overlap at said selected portion of the container.

4. The apparatus set forth in claim 2 wherein said means are such that the images of at least some of said light emitting die surfaces are adjacent to each other at said selected portion of the container.

5. A method of inspecting containers, which includes the steps of:
(a) providing a light source that includes at least one light emitting diode having a light emitting die surface that can be imaged directly from outside of said diode,
(b) focusing said light emitting die surface directly onto a selected portion of a container,
(c) directing an image of said portion of the container onto a light sensor, and
(d) detecting commercial variations at the container as a function of said image.

6. The method set forth in claim 5 wherein said step (a) includes providing a plurality of said light-emitting diodes, and wherein said step (b) includes focusing the light emitting die surfaces of said plurality of light emitting diodes directly onto said selected portion of the container.

7. The method set forth in claim 6 wherein said step (b) is such that at least some images of said light emitting die surfaces overlap at said selected portion of the container.

8. The method set forth in claim 6 wherein said step (b) is such that at least some images of said light emitting die surfaces are adjacent to each other at said selected portion of the container.
